(19) United States
(12) Patent Application Publication
(10) Pub. No.: US 2025/0314288 A1
(43) Pub. Date: Oct. 9, 2025

(54) DRIVE PULLEY ADAPTER FOR A BELT DRIVEN COMPONENT

(71) Applicant: CNH Industrial America LLC, New Holland, PA (US)

(72) Inventor: Nicholas Joseph Laufenberg, Glen Ellyn, IL (US)

(21) Appl. No.: 19/174,432

(22) Filed: Apr. 9, 2025

Related U.S. Application Data
(60) Provisional application No. 63/631,669, filed on Apr. 9, 2024.

(51) Int. Cl. F16H 7/02; F16D 3/06; F16H 55/36; F16H 57/035

(52) U.S. Cl. CPC F16H 7/02; F16D 3/06; F16H 55/36; F16H 57/035

(57) ABSTRACT

Present embodiments disclose a drive pulley adapter for a work vehicle that includes a first housing component that includes a first connection interface configured to engage a first connection interface of a first mounting pad of a first interface component, and a second housing component that includes a second connection interface configured to engage a second connection interface of a second mounting pad of a second interface component. The drive pulley adapter also includes an adapter shaft that includes a first end and a second end, such that the first end includes a first spline configured to engage a spline at an output shaft end of the first mounting pad of the first interface component, and the second end includes a second spline configured to engage a spline at an input shaft end of the second mounting pad of the second interface component.

### CROSS REFERENCE TO RELATED APPLICATION

This application claims priority from and the benefit of U.S. Provisional Application Ser. No. 63/631,669, entitled “DRIVE PULLEY ADAPTER FOR A BELT DRIVEN COMPONENT,” filed Apr. 9, 2024, which is hereby incorporated by reference in its entirety for all purposes.

### BACKGROUND OF THE INVENTION

The present disclosure relates generally to a drive pulley adapter for a belt driven component of an agricultural work vehicle.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used in agricultural operations to facilitate tasks related to cutting, gathering, and processing of crops. Harvesters include systems and components that work together so that the harvester may efficiently carry out the agricultural operations. Certain systems and components interface with one another to accomplish specific portions of the overall operation. For example, a pump drive gearbox may transfer rotational energy to a hydraulic pump that is configured to use the rotational energy to pressurize hydraulic fluid for distribution throughout a network of tubes to various components of the harvester that utilize the pressurized hydraulic fluid in respective operations.

However, certain components that are utilized together in a harvester may have differently sized and/or configured mounting interfaces. Additionally, in the case of the previously described pump drive gearbox-hydraulic pump example, a portion of the rotational energy from the pump drive gearbox may be transferred to an additional component. Mismatched mounting interfaces between components may create difficulties in enabling components to be utilized together, such as the pump drive gearbox and the additional component.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In certain embodiments, a drive pulley adapter for a work vehicle includes a first housing component that includes a first connection interface configured to engage a first connection interface of a first mounting pad of a first interface component, and a second housing component that includes a second connection interface configured to engage a second connection interface of a second mounting pad of a second interface component. The drive pulley adapter also includes an adapter shaft that includes a first end and a second end, such that the first end includes a first spline configured to engage a spline at an output shaft end of the first mounting pad of the first interface component, and the second end includes a second spline configured to engage a spline at an input shaft end of the second mounting pad of the second interface component.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header, in accordance with aspects of the present disclosure;

FIG. 2 is an exploded perspective view of an embodiment of a drive pulley adapter and additional interfacing components that may be employed within the agricultural harvester of FIG. 1, in accordance with aspects of the present disclosure;

FIG. 3 is an additional exploded perspective view of the drive pulley adapter and the additional interfacing components of FIG. 2, in accordance with aspects of the present disclosure;

FIG. 4 is a cross-sectional view of an embodiment of the drive pulley adapter of FIG. 2, in accordance with aspects of the present disclosure; and

FIG. 5 is a flowchart of an embodiment of a method for assembling the drive pulley adapter, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Work equipment is utilized by operators in a variety of industries, including but not limited to agriculture, construction, mining, and heavy commercial applications. For example, agricultural harvesters are used in farming operations to facilitate tasks related to cutting, gathering, and processing of crops. Agricultural harvesters incorporate multiple systems and components that work together to successfully complete these agricultural operations. Certain systems and components interface with one another to accomplish specific portions of the overall operation. For example, a pump drive gearbox may transfer rotational energy to a hydraulic pump that is configured to use the rotational energy to pressurize hydraulic fluid for distribution throughout a network of tubes to various components of the harvester that utilize the pressurized hydraulic fluid in respective operations.

In certain embodiments, a drive pulley adapter is configured to facilitate connection between the pump drive gearbox and the hydraulic pump of the agricultural harvester. For example, the drive pulley adapter includes a housing with multiple portions, and each housing portion is configured to interface with a particularly sized mounting configuration (e.g., SAE International (SAE) mounting configuration). As a result, the drive pulley adapter may enable the connection between a pump drive gearbox and a hydraulic pump that have mismatched mounting configurations (e.g., SAE mounting configurations). Additionally, the drive pulley adapter includes an adapter shaft that is configured to couple an output shaft of the pump drive gearbox and an input shaft of the hydraulic pump to one another.

The drive pulley adapter also includes a belt pulley that is configured to mount onto the adapter shaft, thereby enabling the belt pulley to direct at least a portion of the rotational energy output from the pump drive gearbox toward an additional component. For example, a drive belt engaged with the belt pulley may output rotational energy to a conveyor fan assembly configured to transfer agricultural product (e.g., cotton) from a header to an accumulator. By including the drive pulley adapter in the harvester, harvester components (e.g., the pump drive gearbox and the hydraulic pump) may couple to one another and efficiently transfer energy throughout the agricultural harvester system (e.g., to the conveyor fan assembly).

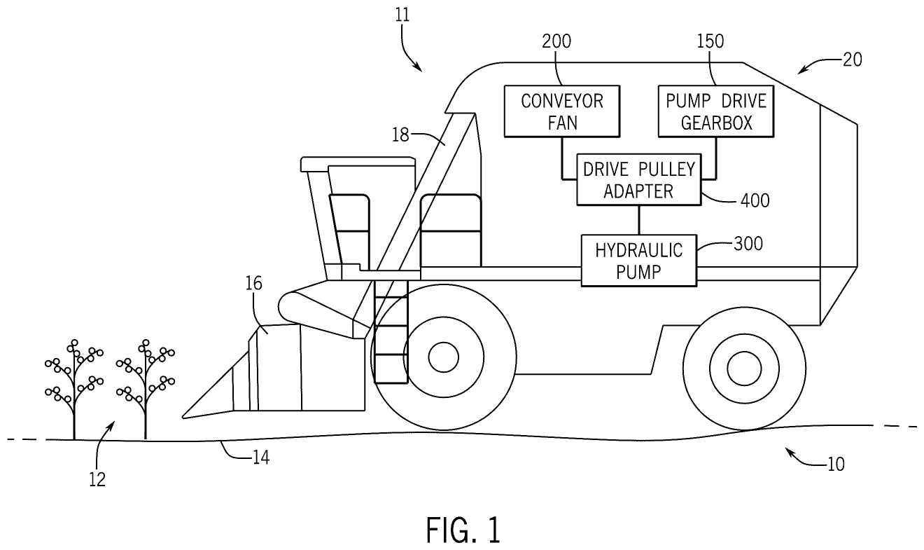

Turning now to the drawings, FIG. 1 is a side view of an embodiment of an agricultural machine system 10 (e.g., harvester, agricultural harvester) having an agricultural product transport assembly 11. The harvester 10 is configured to harvest agricultural product 12 (e.g., cotton) from a field 14 and to form the agricultural product 12 into bales (e.g., agricultural bales). In the illustrated embodiment, the harvester 10 includes a header 16 having drums configured to harvest the agricultural product 12 from the field 14. Additionally, the agricultural product transport assembly 11 of the harvester 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into a baler 20 (e.g., agricultural baler). The baler 20 is supported by and/or mounted within or on a chassis of the harvester 10. The baler 20 may form the agricultural product 12 into round bales. However, in other embodiments, the baler 20 of the harvester 10 may form the agricultural product into square bales, polygonal bales, or bales of other suitable shape(s). After forming the agricultural product 12 into a bale, a bale wrapping system of the harvester 10 wraps the bale with a bale wrap to secure the agricultural product 12 within the bale and to generally maintain a shape of the bale.

In the illustrated embodiment, the harvester 10 includes a pump drive gearbox 150. The pump drive gearbox 150 includes gears, an input shaft, and output shafts. Applying rotational power (e.g., a combination of torque and rotational speed) to the input shaft causes at least one output shaft to rotate. As described in further detail below, the pump drive gearbox 150 may provide rotational power to other component(s) of the harvester 10. In the illustrated embodiment, the pump drive gearbox 150 couples to a drive pulley adapter 400, and the drive pulley adapter 400 couples to a hydraulic pump 300 and one or more conveyor fans 200. As discussed further below, the drive pulley adapter 400 is configured to receive rotational energy output by the pump drive gearbox 150 and to transfer a first portion of the rotational energy to the hydraulic pump 300 and a second portion of the rotational energy to the conveyor fan(s) 200. The drive pulley adapter 400 may be used in other work vehicles, including but not limited to tractors, cotton pickers, excavators, bulldozers, and compactors.

In the illustrated embodiment, the harvester 10 includes the hydraulic pump 300, which is configured to output pressurized hydraulic fluid through a network of conduits to components of the harvester 10 that are powered by the pressurized hydraulic fluid received from the hydraulic pump 300. The hydraulic pump 300 is configured to convert rotational energy from the pump drive gearbox 150 into hydraulic fluid energy. For example, component(s) receiving the pressurized hydraulic fluid from the hydraulic pump 300 may include various motor(s) and/or cylinder(s). In certain embodiments, the hydraulic pump 300 may generate sufficient hydraulic fluid energy to actuate the various motor(s) and cylinder(s) that control certain operations of the harvester 10.

In the illustrated embodiment, the air-assisted conveying system 18 includes a conveyor fan 200 configured to output a conveying air flow through one or more ducts of the air-assisted conveying system 18. Each duct receives the agricultural product 12 (e.g., cotton) from the header 16, and the conveying air flow output by the conveyor fan 200 drives the agricultural product to move through the duct(s) from the header 16 to the accumulator assembly. In some embodiments, the conveyor fan(s) 200 are configured to convert electrical power to rotational energy, and provide the rotational energy to element(s) (e.g., axial fan blades, centrifugal fan blades, etc.) within the conveyor fan(s) 200, that when energized, drive air flow through the duct(s). In certain embodiments, the conveyor fan(s) 200 may be configured to be driven by a drive belt that is engaged with a belt pulley of the drive pulley adapter 400.

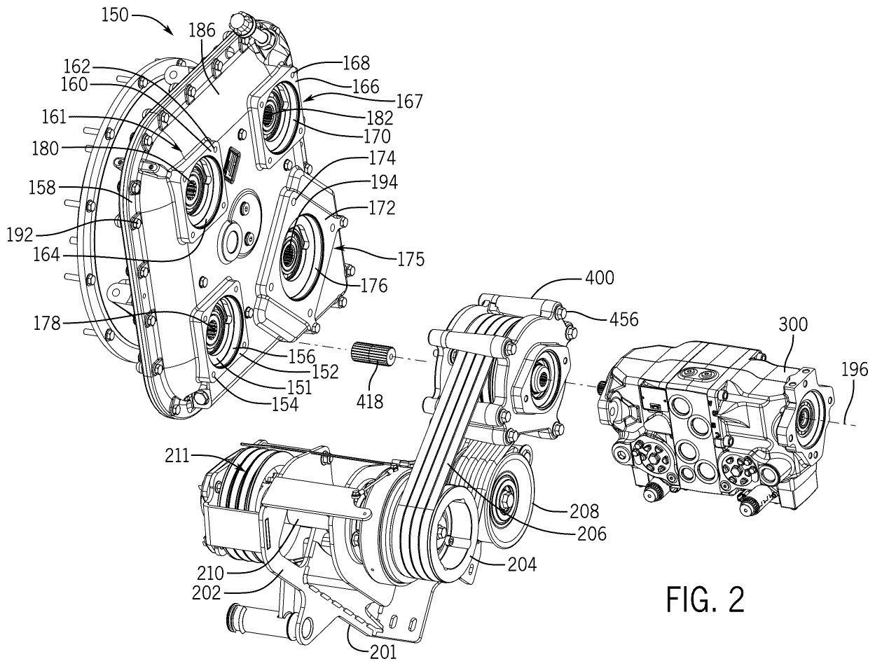

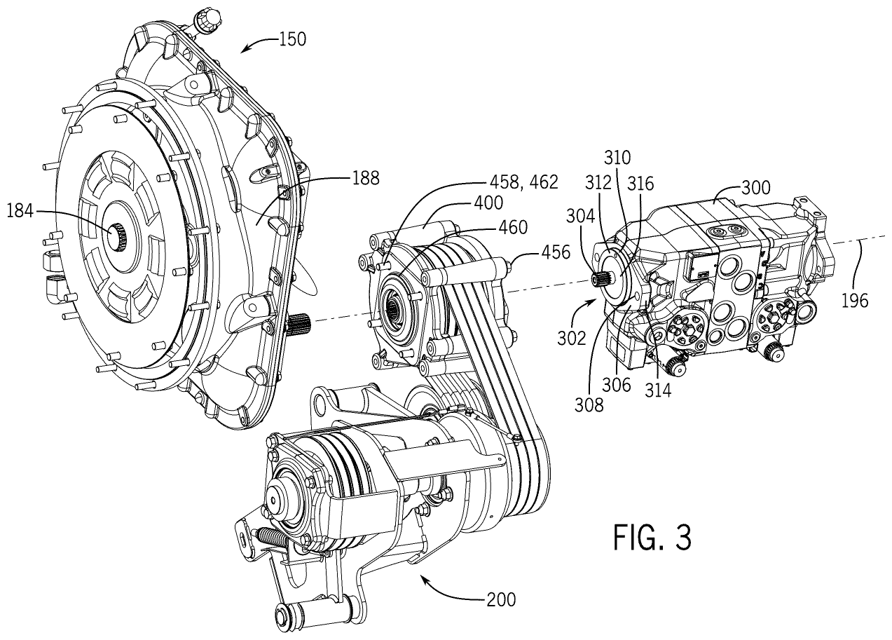

FIGS. 2 and 3 are exploded perspective views of an embodiment of the drive pulley adapter 400 and components that interface with and couple to the drive pulley adapter 400. The drive pulley adapter 400 is configured to mechanically couple to the pump drive gearbox 150 and the hydraulic pump 300. As mentioned above and as discussed in further detail below, the drive pulley adapter 400 is configured to transfer rotational energy from the pump drive gearbox 150 to the hydraulic pump 300 and the conveyor fan(s). In the illustrated embodiment, the pump drive gearbox 150 includes a housing 158 which is configured to provide rigidity and support to internal components, including but not limited to, the input shaft 184, bearings, seals, gears, and the output shafts 178, 180, 182, 194. In some embodiments, the housing 158 includes a front portion 186 and a back portion 188, and the front portion 186 is configured to couple to the back portion 188 of the housing with multiple fasteners 192. The front portion 186, when coupled to the back portion 188, creates an internal cavity to house at least a portion of the aforementioned components (e.g., shafts, bearings, seals, gears, etc.). In other embodiments, the housing may include additional portions, or the front and back portions may be further divided into sub-portions to facilitate maintenance and/or assembly procedures. The housing 158, including the front portion 186 and the back portion 188, may be made from any suitable material, including but not limited to, cast iron, steel, alloy steel, metal, and/or a composite material.

In the illustrated embodiment, the front portion 186 of the housing 158 includes a first SAE mounting pad 151, a second SAE mounting pad 161, a third SAE mounting pad 167, and a fourth SAE mounting pad 175 that are configured to enable the housing 158 to interface with pump(s), adapting component(s), other appropriate interfacing component(s), or a combination thereof, with corresponding SAE mounting pads. For example, SAE International (SAE) has specified multiple mounting pad configurations (e.g., AA, A, B, C, D, E, and F, etc.) that define certain dimensions for various features that facilitate an interface between a motor and an interfacing component, thereby creating standardized configurations for commonly used interfacing component and motor combinations. As a result, a motor with a mounting pad that conforms to the dimensions for a selected configuration, as specified by the SAE, will suitably couple with a interfacing component mounting pad of the corresponding selected configuration (i.e., a motor with an “A” mounting pad may couple to an interfacing component with an “A” mounting pad, a motor with a “B” mounting pad may couple to an interfacing component with a “B” mounting pad, etc.) While SAE mounting pad configurations are disclosed herein, the mounting pad configurations may be provided by another standards organization.

The first SAE mounting pad 151 includes a first interfacing mounting surface 152, a first set of holes 154, a first counterbore 156, and a first output shaft 178. The first interfacing mounting surface 152 is configured to provide a mounting interface for an appropriate interfacing component with a corresponding mounting interface configuration (e.g., corresponding to the same SAE mounting pad configuration as the first SAE mounting pad 151). The first set of holes 154 extends through the first interfacing mounting surface 152 and are arranged in a pattern that corresponds to a specified arrangement per SAE guidelines for the configuration of the first SAE mounting pad 151. In certain embodiments, the first set of holes 154 includes two holes, while in other embodiments, the first set of holes may include four holes. The first set of holes 154 are drilled and tapped to a specified depth such that the holes receive particularly sized fasteners.

Additionally, the first counterbore 156 extends inwardly from the first interfacing mounting surface 152. The first counterbore 156 has a specified diameter and depth, as measured from the first interfacing mounting surface 152, and is configured to accept a pilot feature from a corresponding interfacing component. The diameter of the first counterbore 156 is configured such that the pilot feature engages the first counterbore, while substantially aligning the first output shaft 178 with a mating interfacing component input shaft. The first output shaft 178 is configured to couple to the mating interfacing component input shaft and transfer rotational energy to the interfacing component. In certain embodiments, the first output shaft 178 may include a spline feature that is configured to facilitate the transfer of rotational energy from the pump drive gearbox 150 to the mating interfacing component input shaft. In the illustrated embodiment, the spline feature of the first output shaft 178 is an internal spline feature configured to couple with an external spline feature of the mating interfacing component input shaft. However, in other embodiments, the spline feature of the first output shaft may be an external spline feature configured to couple with an internal spline feature of the mating interfacing component input shaft. In the illustrated embodiment, the first SAE mounting pad 151 and the corresponding features 152, 154, 156, 178 are configured to engage a corresponding mounting pad of the interfacing component (e.g., a four (4) hole SAE “C” pump mount configuration). However, in other embodiments, the first SAE mounting pad 151 may be configured to receive any suitable SAE mounting pad configuration (AA, A, B, D, E, and F, etc.), and these configurations may be considered within the scope of the various embodiments of the present techniques.

The second SAE mounting pad 161 includes a second interfacing mounting surface 160, a second set of holes 162, a second counterbore 164, and a second output shaft 180. The second interfacing mounting surface 160 is configured to provide a mounting interface for an appropriate interfacing component with a corresponding mounting interface configuration (e.g., corresponding to the same SAE mounting pad configuration as the second SAE mounting pad 161). The second set of holes 162 extends through the second interfacing mounting surface 160 and are arranged in a pattern that corresponds to a specified arrangement per SAE guidelines for the configuration of the second SAE mounting pad 161. In certain embodiments, the second set of holes 162 includes two holes, while in other embodiments, the second set of holes may include four holes. The second set of holes 162 are drilled and tapped to a specified depth such that the holes receive particularly sized fasteners

Additionally, the second counterbore 164 extends inwardly from the second interfacing mounting surface 160. The second counterbore 164 has a specified diameter and depth, as measured from the second interfacing mounting surface 160, and is configured to accept a pilot feature from a corresponding interfacing component. The diameter of the second counterbore 164 is configured such that the pilot feature engages the second counterbore, while substantially aligning the second output shaft 180 with a mating interfacing component input shaft. The second output shaft 180 is configured to couple to the mating interfacing component input shaft and transfer rotational energy to the interfacing component. In certain embodiments, the second output shaft 180 may include a spline feature that is configured to facilitate the transfer of rotational energy from the pump drive gearbox 150 to the mating interfacing component input shaft. In the illustrated embodiment, the spline feature of the second output shaft 180 is an internal spline feature configured to couple with an external spline feature of the mating interfacing component input shaft. However, in other embodiments, the spline feature of the second output shaft may be an external spline feature configured to couple with an internal spline feature of the mating interfacing component input shaft. In the illustrated embodiment, the second SAE mounting pad 161 and the corresponding features 160, 162, 164, 180 are configured to engage a corresponding mounting pad of the interfacing component (e.g., a four (4) hole SAE “C” pump mount configuration). However, in other embodiments, the second SAE mounting pad 161 may be configured to receive any suitable SAE mounting pad configuration (AA, A, B, D, E, and F, etc.), and these configurations may be considered within the scope of the various embodiments of the present techniques.

The third SAE mounting pad 167 includes a third interfacing mounting surface 166, a third set of holes 168, a third counterbore 170, and a third output shaft 182. The third interfacing mounting surface 166 is configured to provide a mounting interface for an appropriate interfacing component with a corresponding mounting interface configuration (e.g., corresponding to the same SAE mounting pad configuration as the third SAE mounting pad 167). The third set of holes 168 extends through the third interfacing mounting surface 166 and are arranged in a pattern that corresponds to a specified arrangement per SAE guidelines for the configuration of the third SAE mounting pad 167. In certain embodiments, the third set of holes 168 includes two holes, while in other embodiments, the third set of holes 168 may include four holes. The third set of holes 168 are drilled and tapped to a specified depth such that the holes receive particularly sized fasteners.

Additionally, the third counterbore 170 extends inwardly from the third interfacing mounting surface 166. The third counterbore 170 has a specified diameter and depth, as measured from the third interfacing mounting surface 166, and is configured to accept a pilot feature from a corresponding interfacing component. The diameter of the third counterbore 170 is configured such that the pilot feature engages the third counterbore, while substantially aligning the third output shaft 182 with a mating interfacing component input shaft. The third output shaft 182 is configured to couple to the mating interfacing component input shaft and transfer rotational energy to the interfacing component. In certain embodiments, the third output shaft 182 may include a spline connection that is configured to facilitate the transfer of rotational energy from the pump drive gearbox 150 to the mating interfacing component input shaft. In the illustrated embodiment, the spline feature of the third output shaft 182 is an internal spline feature configured to couple with an external spline feature of the mating interfacing component input shaft. However, in other embodiments, the spline feature of the third output shaft may be an external spline feature configured to couple with an internal spline feature of the mating interfacing component input shaft. In the illustrated embodiment, the third SAE mounting pad 167 and the corresponding features 166, 168, 170, 182 are configured to engage a corresponding mounting pad of the interfacing component (e.g., a four (4) hole SAE “C” pump mount configuration). However, in other embodiments, the third SAE mounting pad 167 may be configured to receive any suitable SAE mounting pad configuration (AA, A, B, D, E, and F, etc.), and these configurations may be considered within the scope of the various embodiments of the present techniques.

The fourth SAE mounting pad 175 includes a fourth interfacing mounting surface 172, a fourth set of holes 174, a fourth counterbore 176, and a fourth output shaft 194. The fourth interfacing mounting surface 172 is configured to provide a mounting interface for an appropriate interfacing component with a corresponding mounting interface configuration (e.g., corresponding to the same SAE mounting pad configuration as the fourth SAE mounting pad 175). The fourth set of holes 174 extends through the fourth interfacing mounting surface 172, and are arranged in a pattern that corresponds to a specified arrangement per SAE guidelines for the configuration of the fourth SAE mounting pad 175. In certain embodiments, the fourth set of holes 174 includes two holes, while in other embodiments, the fourth set of holes may include four holes. The fourth set of holes 174 are drilled and tapped to a specified depth such that the holes receive particularly sized fasteners.

Additionally, the fourth counterbore 176 extends inwardly from the fourth interfacing mounting surface 172. The fourth counterbore 176 has a specified diameter and depth, as measured from the fourth interfacing mounting surface 172, and is configured to accept a pilot feature from a corresponding interfacing component. The diameter of the fourth counterbore 176 is configured such that the pilot feature engages the fourth counterbore, while substantially aligning the fourth output shaft 194 with a mating interfacing component input shaft. The fourth output shaft 194 is configured to couple to the mating interfacing component input shaft and transfer rotational energy to the interfacing component. In certain embodiments, the fourth output shaft 194 may include a spline connection that is configured to facilitate the transfer of rotational energy from the pump drive gearbox 150 to the mating interfacing component input shaft. In the illustrated embodiment, the spline feature of the fourth output shaft 194 is an internal spline feature configured to couple with an external spline feature of the mating interfacing component input shaft. However, in other embodiments, the spline feature of the fourth output shaft 194 may be an external spline feature configured to couple with an internal spline feature of the mating interfacing component shaft. In the illustrated embodiment, the fourth SAE mounting pad 175 and the corresponding features 172, 174, 176, 194 are configured to engage a corresponding mounting pad of the interfacing component (e.g., a four (4) hole, SAE “D” pump mount configuration). However, in other embodiments, the fourth SAE mounting pad 175 may be configured to receive any suitable SAE mounting pad configuration (AA, A, B, C, E, and F, etc.), and these configurations may be considered within the scope of the various embodiments of the present techniques.

As previously discussed, the harvester includes one or more conveyor fans configured to output a conveying airflow through one or more ducts to drive the agricultural product to move from the header to the accumulator assembly. In the illustrated embodiment, a conveyor fan is indirectly coupled to the drive pulley adapter 400 via a belt drive system 201. The belt drive system 201 includes a frame 202, a driven sheave 204, a drive belt 206, a deflector sheave 208, a shaft 210, and a conveyor fan drive sheave 211. The frame 202 is configured to provide support and rigidity to various components of the belt drive system 201, and the frame 202 may be mounted to the chassis of the harvester. The frame 202 may be made from any suitable material(s), including but not limited to, cast iron, steel, alloy steel, metal, a composite, or a combination thereof.

The frame 202 is configured to support a shaft 210. The shaft 210, when driven to rotate by the driven sheave 204, is configured to drive the conveyor fan drive sheave 211 to rotate. The conveyor fan drive sheave 211 may be coupled to a conveyor fan sheave via a respective belt. Accordingly, rotation of the conveyor fan drive sheave 211 drives rotation of the conveyor fan sheave, thereby providing the conveyor fan with rotational energy. The shaft 210 may be made from any suitable material(s), including but not limited to steel, alloy steel, aluminum, or a combination thereof. In the illustrated embodiment, a first end of the shaft 210 is non-rotatably coupled to the driven sheave 204, such that when the driven sheave 204 rotates, the shaft 210 rotates. In certain embodiments, the driven sheave 204 is coupled to the first end of the shaft 210 with multiple fasteners. In other embodiments, the driven sheave 204 may be non-rotatably coupled to the first end of the shaft via an interference fit (e.g., the diameter at the first end of the shaft 210 is larger than the inner diameter of the driven sheave), via a splined connection, etc.

As discussed above, the driven sheave 204 is non-rotatably coupled to the shaft 210. Moreover, the driven sheave 204 includes an outer circumferential surface that is configured to receive the drive belt 206. In the illustrated embodiment, the drive belt 206 is configured to engage the outer circumferential surface of the driven sheave 204, thereby rotatably connecting the driven sheave 204 with the belt pulley of the drive pulley adapter 400. As illustrated, the outer circumferential surface of the driven sheave 204 includes multiple tapered grooves that engage matching tapered protrusions of the drive belt 206. The tapered grooves in the outer circumferential surface of the driven sheave 204 are formed by an alternating series of peaks and valleys, and each tapered protrusion of the drive belt 206 fits into a respective tapered groove of the driven sheave 204. The interface between the tapered grooves of the driven sheave 204 and the tapered protrusions of the drive belt 206 facilitates retention of the drive belt 206 and enables the drive belt to transfer rotational energy from the belt pulley of the drive pulley adapter to the driven sheave 204. In the illustrated embodiment, the driven sheave 204 includes four (4) tapered grooves configured to receive a drive belt 206 with four (4) corresponding tapered protrusions. In other embodiments, the driven sheave 204 and drive belt 206 may have fewer or more grooves and protrusions (1, 2, 3, 5, 6, 7, 8, etc.). In a non-limiting embodiment, the drive belt may be a group of individual belts with singular or double tapered protrusions, that when used together, accomplish similar functionality to that of a single belt with multiple tapered protrusions.

Turning to FIG. 3, the harvester includes a hydraulic pump 300. As discussed previously, the hydraulic pump 300 is configured to output pressurized hydraulic fluid through a network of conduits to components of the harvester that operate based on the pressurized hydraulic fluid received from the hydraulic pump 300. The hydraulic pump 300 is configured to convert rotational energy from the pump drive gearbox 150 into hydraulic fluid energy. The hydraulic pump 300 includes a pump mounting pad 302 that is configured to enable the hydraulic pump 300 to couple to the drive pulley adapter 400. The pump mounting pad 302 includes a pump shaft 304, a pump flange 314, and a circumferential surface 310.

The pump shaft 304 of the pump mounting pad 302 is configured to couple to an adapter shaft and to transfer rotational energy from the adapter shaft to components of the hydraulic pump 300. In the illustrated embodiment, the pump shaft 304 includes an external spline configured to engage a corresponding internal spline of the adapter shaft, thereby non-rotatably coupling the shafts to one another. However, in other embodiments, the spline of the pump shaft may be an internal spline configured to couple with an external spline of the adapter shaft. The pump shaft 304 is configured to protrude a specified distance from the circumferential surface 310, thereby enabling the pump shaft 304 to engage with the adapter shaft.

Additionally, the pump mounting pad 302 includes a pump flange 314 configured to couple the hydraulic pump 300 to the drive pulley adapter housing. The pump flange 314 includes a pump flange surface 306 and pump fastener holes 308 that enable the hydraulic pump 300 to couple to the drive pulley adapter housing. The pump flange surface 306 is configured to contact a corresponding mounting pad on the drive pulley adapter, and the pump flange surface 306 is substantially planar. Additionally, the pump flange surface 306 is configured to be substantially perpendicular to the rotational axis 196 of the pump shaft 304. The pump fastener holes 308 are disposed on the pump flange surface 306. In the illustrated embodiment, the pump flange 314 includes two (2) holes, with one hole on a first side of the pump shaft 304, and a second hole on a second side of the pump shaft. Each hole is disposed an equal distance from the pump shaft 304, and each hole is substantially parallel to the rotational axis 196 of the pump shaft. In the illustrated embodiment, the pump mounting pad 302 conforms to the specifications of an SAE size “B” flange connection, however in other embodiments, the pump mounting pad may conform to various other SAE connection sizes (e.g., AA, A, C, D, etc.).

The pump mounting pad 302 includes a pump pilot feature 316 configured to engage a corresponding counterbore of the interfacing component. The pump pilot feature 316 includes a planar pilot feature surface 312 and the circumferential surface 310. The circumferential surface 310 is disposed about an axis that is substantially coaxial with the rotational axis 196 of the pump shaft. As a result, as the circumferential surface 310 engages a circumferential surface of the corresponding counterbore of the drive pulley adapter housing, the circumferential surface 310, as part of the pump pilot feature 316, facilitates alignment of the pump shaft 304 with the corresponding adapter shaft of the drive pulley adapter. The planar pilot feature surface 312 is substantially parallel to the pump flange surface 306 and is axially offset (e.g., with respect to the rotational axis 196) by a specified distance from the pump flange surface 306. The offset distance enables the pump pilot feature to have sufficient engagement with the corresponding counterbore of the drive pulley adapter housing.

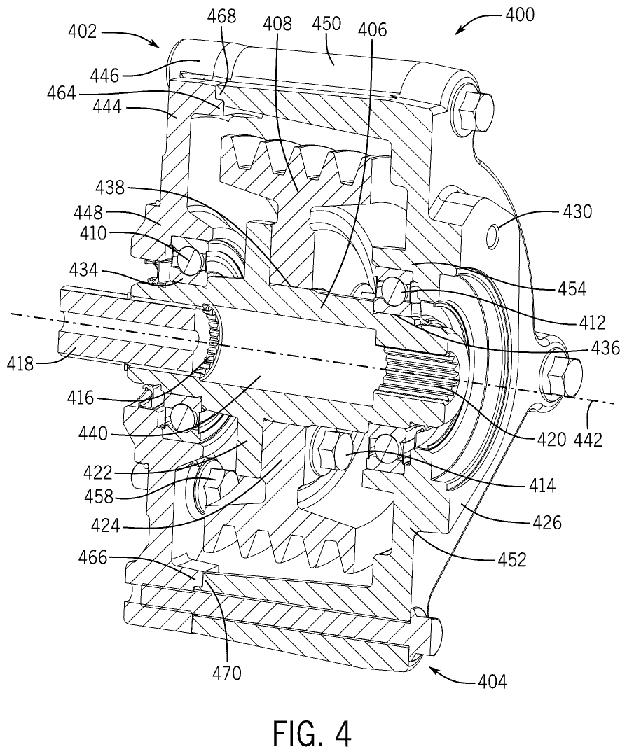

As shown in FIG. 1, the drive pulley adapter 400 is disposed within an interior of the harvester, and as shown in FIGS. 2-3, the drive pulley adapter 400 is disposed between the pump drive gearbox 150 and the hydraulic pump 300. FIG. 4 is a cross-sectional view of the drive pulley adapter 400 of FIG. 2. As described in further detail below, a first end of the drive pulley adapter 400 couples to the pump drive gearbox via one of the available SAE mounting pads, and a second end of the drive pulley adapter couples to the hydraulic pump via the pump mounting pad. As discussed previously, the drive pulley adapter 400 is configured to receive rotational energy from the pump drive gearbox and to transfer at least a portion of the rotational energy to the hydraulic pump. Additionally, the drive pulley adapter 400 is configured to transfer a portion of the received rotational energy to the conveyor fan via the drive belt and belt drive system.

In the illustrated embodiment, the drive pulley adapter 400 includes an adapter shaft 406. The adapter shaft 406 includes a first end 416, a second end 420, a radial flange 422, a first bearing journal 434, a second bearing journal 436, a belt pulley mounting journal 438, and an internal bore 440. In the illustrated embodiment, the first bearing journal 434 is disposed proximate to the first end 416 of the adapter shaft, and the second bearing journal 436 is disposed proximate to the second end 420 of the adapter shaft. In certain embodiments, the first bearing journal 434 has a substantially similar diameter to the second bearing journal 436. In certain embodiments, the first bearing journal may have a larger diameter than the second bearing journal, and in other embodiments, the first bearing journal may have a smaller diameter than the second bearing journal. As discussed in more detail below, the first bearing journal 434 is configured to receive a first bearing 410, and the second bearing journal 436 is configured to receive a second bearing 412.

The radial flange 422 is disposed between the first end 416 and the second end 420 of the adapter shaft 406. In the illustrated embodiment, the radial flange 422 is configured to interface with a hub of a belt pulley 408. The radial flange 422 includes a mounting face that is substantially planar and perpendicular to a rotational axis 442 of the adapter shaft 406. The radial flange 422 is configured to enable the belt pulley 408 to couple to the adapter shaft 406, thereby facilitating the transfer of rotational energy from the adapter shaft 406 to the belt pulley 408. The belt pulley mounting journal 438 is configured to interface with an interior surface of the belt pulley 408. In the illustrated embodiment, the belt pulley mounting journal 438 has a diameter that is larger than the first bearing journal 434 and the second bearing journal 436. In other embodiments, the diameter of the belt pulley mounting journal may be substantially similar to the diameter of the first bearing journal and the second bearing journal.

The adapter shaft includes an internal bore 440 that extends along an entirety of the length of the adapter shaft. In a non-limiting embodiment, the internal bore 440 has a central axis that is coaxial with the rotational axis 442 of the adapter shaft 406. The first end 416 of the adapter shaft 406 includes an internal spline that extends for a length along the internal bore 440. The internal spline at the first end 416 of the adapter shaft 406 is configured to engage an external spline of a connector shaft 418 to transfer rotational energy from the connector shaft 418 to the adapter shaft 406, as discussed later in further detail. The second end 420 of the adapter shaft 406 includes an internal spline that extends for a length along the internal bore 440. The internal spline at the second end 420 of the adapter shaft 406 is configured to engage an external spline of a shaft of an interfacing component to transfer rotational energy from the adapter shaft to the interfacing component shaft. In certain embodiments, the interfacing component is a hydraulic pump, or another appropriate component that includes a shaft configured to couple to the second end 420 of the adapter shaft 406. The adapter shaft 406 may be made from steel, alloy steel, a composite, or a combination thereof.

As discussed previously, the belt pulley 408 is configured to couple to the radial flange 422 of the adapter shaft 406 and to interface with the belt pulley mounting journal 438. In the illustrated embodiment, the belt pulley 408 includes a pulley hub 424 configured to couple to the radial flange 422. Additionally, multiple fasteners 414 couple the pulley hub 424 to the radial flange 422. In certain embodiments, four (4) fasteners may couple the pulley hub 424 to the radial flange 422, while in other embodiments, more or fewer (2, 3, 5, 6, etc.) fasteners may couple the pulley hub to the radial flange. In a non-limiting embodiment, the fasteners are hex head capscrews. In other embodiments, the fasteners are socket-head capscrews, structural bolts, or other suitable fastener types. The radial flange 422 may be drilled and tapped with an appropriate thread size tap that corresponds to threads on the fasteners, or the radial flange may be drilled with thru-holes, and nuts may be coupled to the distal ends of the fasteners to couple the pulley hub to the radial flange.

In the illustrated embodiment, the belt pulley 408 includes an outer circumferential surface that is configured to receive the drive belt. As illustrated, the outer circumferential surface of the belt pulley 408 includes multiple tapered grooves that engage with matching tapered protrusion of the drive belt. The tapered grooves in the outer circumferential surface of the belt pulley 408 include an alternating series of peaks and valleys, and each tapered protrusion of the drive belt fits into a respective tapered groove of the belt pulley 408. This interface between the tapered grooves of the belt pulley 408 and the drive belt facilitates retention of the drive belt and enables the drive belt to transfer rotational energy between the belt pulley 408 and the driven sheave 204 of the belt drive system. In the illustrated embodiment, the belt pulley 408 includes three (3) tapered grooves configured to receive the drive belt with three (3) corresponding tapered protrusions. In other embodiments, the belt pulley 408 and drive belt may have fewer or more grooves and protrusions (1, 2, 4, 5, 6, 7, 8, etc.).

The drive pulley adapter includes a housing that is separated into at least two components. In the illustrated embodiment, the drive pulley adapter housing includes a first housing component 402 and a second housing component 404. The first housing component 402 includes a hub portion 448, a web portion 444, and multiple tubular portions 446. The first housing component 402 is configured to provide support and rigidity to components of the drive pulley adapter 400, including, but not limited to, a first bearing 410 and the adapter shaft 406. For example, the hub portion 448 includes a bearing bore configured to receive and enable the first bearing 410 to mount into the first housing component 402. Additionally, the first housing component 402 is configured to enable the drive pulley adapter 400 to interface with one of the SAE mounting pads of the pump drive gearbox. In certain embodiments, the first housing component 402 may be configured to interface with a particular SAE mounting pad configuration (e.g., AA, A, B, C, D, etc.). In the illustrated embodiment and as shown in FIGS. 2 and 3, the hub portion 448 of the first housing component 402 includes a first housing mounting pad 460 configured to interface with a corresponding SAE mounting pad of the pump drive gearbox, and the web portion 444 includes holes 462 configured to receive fasteners 458 that engage the set of holes of the corresponding SAE mounting pad of the pump drive gearbox to couple the first housing component 402 to the pump drive gearbox.

The tubular portions 446 of the first housing component 402 are circumferentially distributed about an outer radial portion of the web portion 444. The multiple tubular portions 446 are configured to enable the first housing component 402 to receive fasteners 456 that couple the first housing component 402 to the second housing component 404. As shown in FIGS. 2 and 3, the first housing component 402 includes six (6) tubular portions 446 that are each configured to accept the fastener 456 to couple the first housing component 402 to the second housing component 404. However, in other embodiments, the first housing component may include more or fewer tubular portions (e.g., 2, 3, 4, 5, 7, 8, 9, etc.). The first housing component 402 and associated components (e.g., the hub portion 448, the web portion 444, and the multiple tubular portions 446) may be made from any suitable material(s), including but not limited to steel, cast iron, alloy steel, composites, otherwise appropriate material(s), or a combination thereof.

The second housing component 404 includes a hub portion 454, a web portion 452, and multiple tubular portions 450. The second housing component 404 is configured to provide support and rigidity to components of the drive pulley adapter 400, including, but not limited to, a second bearing 412 and the adapter shaft 406. For example, the hub portion 454 includes a bearing bore configured to receive and enable the second bearing 412 to mount into the second housing component 404. Additionally, the second housing component 404 is configured to enable the drive pulley adapter 400 to interface with the SAE mounting pad of the hydraulic pump. In certain embodiments, the second housing component 404 may be configured to interface with a particular SAE mounting pad configuration (e.g., AA, A, B, C, D, etc.). In the illustrated embodiment, the hub portion 454 of the second housing component 404 includes a second housing mounting pad 426 configured to interface with the pump mounting pad of the hydraulic pump, and the hub portion 454 includes fastener holes 430 configured to receive fasteners that engage the set of holes of the corresponding SAE mounting pad of the hydraulic pump to couple the second housing component 404 to the hydraulic pump.

The tubular portions 450 of the second housing component 404 are circumferentially distributed about an outer radial portion of the web portion 452. The multiple tubular portions 450 are configured to enable the second housing component 404 to receive fasteners that couple the first housing component 402 to the second housing component 404. As shown in FIGS. 2 and 3, the second housing component 404 includes six (6) tubular portions 450 that are each configured to accept that fastener that couples the first housing component 402 to the second housing component 404. However, in other embodiments, the second housing component may include more or fewer tubular portions (e.g., 2, 3, 4, 5, 7, 8, 9, etc.). The second housing component 404 and associated components (e.g., the hub portion 454, the web portion 452, and the multiple tubular portions 450) may be made from any suitable material(s), including but not limited to steel, cast iron, alloy steel, composites, otherwise appropriate material(s), or a combination thereof.

Additionally, the tubular portions 446 of the first housing component 402 include alignment features 464, 466 configured to interface with corresponding alignment features 468, 470 on the tubular portions 450 of the second housing component 404. In the illustrated embodiment, each first housing component alignment feature 464, 466 includes an outer circumferential surface, such that taken together, the outer circumferential surfaces form a portion of an outer circumferential surface of a cylinder having an axis coaxial with the axis of the bearing bore of the hub portion 448. Also, each second housing component alignment feature 468, 470 includes an inner circumferential surface, such that taken together, the inner circumferential surfaces form a portion of an inner circumferential surface of a cylinder having an axis coaxial with the axis of the bearing bore of the hub portion 454. The alignment features 464, 466 enable the bearing bore axis of the hub portion 448 of the first housing component 402 to align with the bearing bore axis of the hub portion 454 of the second housing component 404. While the alignment features include circumferential surfaces in the illustrated embodiment, in other embodiments, the alignment features may include any other suitable components (e.g., protrusions configured to engage recesses, ridges configured to engage slots, etc.). Furthermore, in certain embodiments, the alignment features may be omitted.

In the illustrated embodiment, as described above, the first housing component 402 is configured to couple to the pump drive gearbox via one of the associated SAE mounting pads, and the second housing component 404 is configured to couple to the hydraulic pump via the associated SAE mounting interface. However, in other embodiments, the first housing component 402 may be configured to couple to the hydraulic pump, and the second housing component 404 may be configured to couple to the pump drive gearbox. Additionally, the first housing component 402 and the second housing component 404, when coupled together to form the drive pulley adapter 400, enable the pump drive gearbox and the hydraulic pump to couple to one another, even if the corresponding SAE mounting pads on the respective components do not match. For example, in certain embodiments, the hydraulic pump may include an SAE “B” mounting pad, and the pump drive gearbox may include an SAE “C” mounting pad, which are not compatible with one another. However, in certain embodiments, the first housing component 402 may have an SAE “C” mounting pad to facilitate coupling the drive pulley adapter 400 to the pump drive gearbox, and the second housing component 404 may have an SAE “B” mounting pad to facilitate coupling the drive pulley adapter 400 to the hydraulic pump, thereby enabling coupling the hydraulic pump to the pump drive gearbox via the drive pulley adapter 400.

The first bearing 410 of the drive pulley adapter 400 is disposed in the hub portion 448 of the first housing component 402, and the second bearing 412 is disposed in the hub portion 454 of the second housing component 404. The first bearing 410 and the second bearing are configured to facilitate rotational motion and provide support for the adapter shaft 406. In certain embodiments, each of the first bearing 410 and the second bearing 412 may be a cylindrical roller bearing, a single row tapered roller bearing, a spherical bearing, or any other suitable bearing configuration. The first bearing 410 and second bearing 412 may have the same configurations and diameters, or the bearings may have different configurations and/or different diameters.

Additionally, the drive pulley adapter 400 includes a connector shaft 418 configured to couple the adapter shaft 406 to the corresponding output shaft of the pump drive gearbox. In the illustrated embodiment, the connector shaft 418 includes an external spline that spans an entire length of the connector shaft 418 along the rotational axis 442 of the adapter shaft. The connector shaft is configured to interface with the first end 416 of the adapter shaft 406 and slidably couple to the internal spline at the first end 416, and the connector shaft is configured to couple to the corresponding output shaft of the pump drive gearbox. In other embodiments, the connector shaft may include an internal bore with an internal spline that spans the entire length of the connector shaft. The connector shaft 418 is configured to transfer rotational energy output from the pump drive gearbox to the adapter shaft 406 of the drive pulley adapter 400.

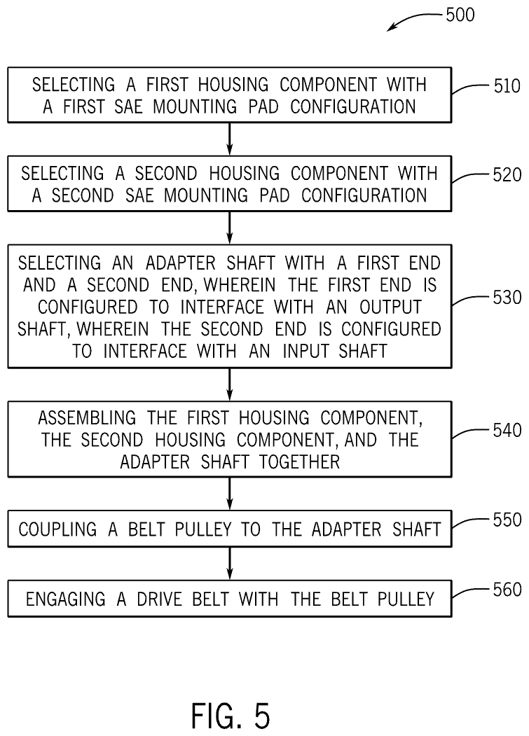

FIG. 5 is a flowchart of an embodiment of a method 500 for assembling a drive pulley adapter for use within a harvester. First, in block 510, a user selects a first housing component of a housing with a first SAE mounting pad configuration. The first housing component includes the first SAE mounting pad configured to match the SAE mounting pad of an interfacing component (e.g., pump drive gearbox, hydraulic pump, etc.). In certain embodiments, the first SAE mounting pad configuration of the first housing component conforms with the features and dimensions specified in a particular SAE mounting pad configuration (e.g., AA, A, B, C, D, etc.). In block 520, the user selects a second housing component of the housing with a second SAE mounting pad configuration. The second housing component includes the second SAE mounting pad configured to match the SAE mounting pad of an interfacing component (e.g., pump drive gearbox, hydraulic pump, etc.). In certain embodiments, the second SAE mounting pad configuration of the second housing component conforms with the features and dimensions specified in a particular SAE mounting pad configuration (e.g., AA, A, B, C, D, etc.).

In block 530, a user selects an adapter shaft with a first end and a second end, such that the first end is configured to interface with an output shaft of an interfacing component, and the second end is configured to interface with an input shaft of an additional interfacing component. In certain embodiments, the first end of the adapter shaft includes a spline that is configured to engage a corresponding spline of a pump drive gearbox output shaft. Additionally, the second end of the adapter shaft includes a spline that is configured to engage a corresponding spline of a hydraulic pump input shaft. Accordingly, the first end of the adapter shaft is configured to couple to an output shaft that corresponds to the first SAE mounting pad of the first housing component, and the second end of the adapter shaft is configured to couple to an input shaft that corresponds to the second SAE mounting pad of the second housing component. At block 540, the user assembles the first housing component, the second housing component, and the adapter shaft together to form the drive pulley adapter. In certain embodiments, the first housing component may be proximate to the first end of the adapter shaft, and the second housing component may be proximate to the second end of the adapter shaft. As constructed with the selected parts from the previous blocks, the drive pulley adapter may be configured to enable interfacing components of the harvester that ordinarily may not directly couple to one another (e.g., a first component with an SAE “B” mounting pad and a second component with an SAE “D” mounting pad) to indirectly couple to one another via the drive pulley adapter.

In block 550, a user couples a belt pulley to the adapter shaft. The belt pulley includes a pulley hub configured to couple to the radial flange of the adapter shaft. In certain embodiments, four (4) fasteners may couple the pulley hub to the radial flange, while in other embodiments, more or fewer (2, 3, 5, 6, etc.) fasteners may couple the pulley hub to the radial flange. In a non-limiting embodiment, the fasteners are hex head capscrews. In other embodiments, the fasteners are socket-head capscrews, structural bolts, or other suitable fastener types. The radial flange may be drilled and tapped with an appropriate thread size tap that corresponds to threads on the fasteners, or the radial flange may be drilled with thru-holes, and nuts may be coupled to the distal ends of the fasteners to couple the pulley hub to the radial flange.

In block 560, a user engages a drive belt with the belt pulley. The outer circumferential surface of the belt pulley includes multiple tapered grooves that engage with matching tapered protrusion of the drive belt. The tapered grooves in the outer circumferential surface of the belt pulley include an alternating series of peaks and valleys, and each tapered protrusion of the drive belt fits into a respective tapered groove of the belt pulley.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A drive pulley adapter for a work vehicle, comprising:
a first housing component comprising a first connection interface configured to engage a first connection interface of a first mounting pad of a first interface component;
a second housing component comprising a second connection interface configured to engage a second connection interface of a second mounting pad of a second interface component;
an adapter shaft comprising a first end, a second end, and a mounting journal, wherein the first end comprises a first spline configured to engage a spline at an output shaft end of the first mounting pad of the first interface component, and the second end comprises a second spline configured to engage a spline at an input shaft end of the second mounting pad of the second interface component; and
a belt pulley disposed on the mounting journal of the adapter shaft;
wherein the second housing component is coupled to the first housing component to form a housing that houses the belt pulley and the adapter shaft.

2. The drive pulley adapter of claim 1, wherein the adapter shaft comprises a radial flange disposed between the first end and the second end of the adapter shaft, and the radial flange comprises a plurality of mounting holes.

3. The drive pulley adapter of claim 1, wherein the first interface component comprises a pump drive gearbox of the work vehicle.

4. The drive pulley adapter of claim 1, wherein the second interface component comprises a hydraulic pump of the work vehicle.

5. The drive pulley adapter of claim 1, wherein the belt pulley comprises a plurality of tapered grooves.

6. The drive pulley adapter of claim 2, wherein the belt pulley is configured to couple to the radial flange of the adapter shaft.

7. The drive pulley adapter of claim 1, wherein the first housing component comprises:
a first hub portion configured to receive a first bearing;
a first web portion disposed radially about the first hub portion, wherein the first web portion includes a first outer circumferential surface; and
a first plurality of tubular portions circumferentially distributed about the first outer circumferential surface of the first web portion, wherein the first plurality of tubular portions comprise a first alignment feature.

8. The drive pulley adapter of claim 7, wherein the second housing component comprises:
a second hub portion configured to receive a second bearing;
a second web portion disposed radially about the second hub portion, wherein the second web portion includes a second outer circumferential surface; and
a second plurality of tubular portions circumferentially distributed about the second outer circumferential surface of the second web portion, wherein the second plurality of tubular portions comprise a second alignment feature configured to interface with the first alignment feature on the first plurality of tubular portions to align an axis of the second hub portion with an axis of the first hub portion.

9. A drive pulley adapter for a work vehicle, comprising:
a first housing component comprising a first bearing bore and a first connection interface configured to engage a first connection interface of a first mounting pad of a first interface component;
a second housing component comprising a second bearing bore and a second connection interface configured to engage a second connection interface of a second mounting pad of a second interface component;
an adapter shaft comprising a first end, a second end, a first mounting journal, a second mounting journal, a third mounting journal, wherein the first end comprises a first spline spanning from the first end for a first length, wherein the first spline is configured to engage a spline at an output shaft end of the first mounting pad of the first interface component, wherein the second end comprises a second spline spanning from the second end for a second length, wherein the second spline is configured to engage a spline at an input shaft end of the second mounting pad of the second interface component;
a belt pulley disposed on the first mounting journal of the adapter shaft;
a first bearing comprising a first outside surface and a first inside surface, wherein the first inside surface is configured to interface with the second mounting journal, and the first outside surface is configured to interface with the first bearing bore; and
a second bearing comprising a second outside surface and a second inside surface, wherein the second inside surface is configured to interface with the third mounting journal, and the second outside surface is configured to interface with the second bearing bore;
wherein the second housing component is coupled to the first housing component to form a housing that houses the belt pulley, the adapter shaft, the first bearing, and the second bearing.

10. The drive pulley adapter of claim 9, wherein the adapter shaft comprises a radial flange disposed between the first and second ends of the adapter shaft.

11. The drive pulley adapter of claim 10, wherein the belt pulley comprises a pulley hub, wherein the pulley hub is configured to enable the belt pulley to couple to the radial flange of the adapter shaft.

12. The drive pulley adapter of claim 9, wherein the first interface component comprises a pump drive gearbox of the work vehicle.

13. The drive pulley adapter of claim 9, wherein the second interface component comprises a hydraulic pump the work vehicle.

14. The drive pulley adapter of claim 9, comprising a connector shaft configured to interface with the first spline of the adapter shaft.

15. The drive pulley adapter of claim 14, wherein the connector shaft comprises an external spline that spans a full length of the connector shaft, and is configured to couple the output shaft end of the first interface component with the first end of the adapter shaft.

16. A method, comprising:
selecting a first housing component of a housing of a drive pulley adapter, wherein the first housing component has a first connection interface, and the first housing component selection is based on a pump drive gearbox mounting pad configuration;
selecting a second housing component of the housing of the drive pulley adapter, wherein the second housing component has a second connection interface, and the second housing component selection is based on a hydraulic pump mounting pad configuration;
selecting an adapter shaft with a first end and a second end based on the pump drive gearbox mounting pad configuration and the hydraulic pump mounting pad configuration, wherein the first end is configured to couple to an output shaft of the pump drive gearbox, the second end is configured to couple to an input shaft of the hydraulic pump, and the adapter shaft is configured to support a belt pulley configured to engage a drive belt; and
coupling the first housing component, the second housing component, and the adapter shaft to one another.

17. The method of claim 16, comprising coupling the belt pulley to the adapter shaft.

18. The method of claim 17, comprising engaging the drive belt with the belt pulley.

19. The method of claim 16, wherein the first connection interface and the first end of the adapter shaft collectively form an SAE “C” mounting pad configuration, and the pump drive gearbox mounting pad configuration is the SAE “C” mounting pad configuration.

20. The method of claim 19, wherein the second connection interface and the second end of the adapter shaft collectively form an SAE “B” mounting pad configuration, and the hydraulic pump mounting pad configuration is the SAE “B” mounting pad configuration.
